(19) United States
(12) Patent Application Publication
(10) Pub. No.: US 2010/0292815 A1
(43) Pub. Date: Nov. 18, 2010

(54) CONTROL SYSTEM AND CONTROL METHOD FOR INTELLIGENT SOLAR STREET LAMP

(76) Inventor: Yun Pan, Shenzhen (CN)

Correspondence Address: HAMRE, SCHUMANN, MUELLER & LARSON, P.C., P.O. BOX 2902, MINNEAPOLIS, MN, 55402-0902, US

(21) Appl. No.: 12/684,080

(22) Filed: Jan. 7, 2010

(30) Foreign Application Priority Data
May 12, 2009 (CN) 200910136369.4

(51) Int. Cl. G06F 17/00; H05B 37/02; H02J 7/00

(52) U.S. Cl. 700/90; 315/158; 320/101

(57) ABSTRACT

An intelligent control system and control method for solar street lamps includes at least a single pole system and a manager with wireless communication interfaces respectively. The single pole system includes a controller, an LED lamp, a solar panel and a storage battery. The controller monitors the operating data logging and the manager modifies the parameter settings and saves the parameters in the controller. The control system and method provide a solution to the centralized control over the self-governed solar street lamps, and can be used to accurately set, control and monitor each street lamp in the whole solar street lamp system, and check the operating conditions of each street lamp, so that the managerial personnel know the running conditions of each piece of solar street lamp and find out the problems hidden in the street lamps for the purpose of repair and nipping them in the bud.

### BACKGROUND OF THE INVENTION

1. Field of the Invention

The present invention relates to a control system for street lamps and, more particularly, to a control system and control method for intelligent solar street lamps. The control system is designed for the solar street lamps, especially for control of solar LED street lamps system.

2. Description of Related Art

With high-speed urbanization and improvement in road infrastructure, the road lighting tends to expand quickly and accounts for a relatively high proportion (about 12%) in the structure of electricity utilization. Therefore, the energy saving relevant to the street lamps has hopeful prospects, at present the monitoring and maintenance of street lamps also involves a great amount of work.

Traditional street lamp control systems are to divide the lamps into several groups on one street and connect them in parallel to the street lamp control box which controls the power supply to the street lamps. In recent years, multiple types of solar street lamps spring up and they are not dependent upon the power supply from the municipal power network and save a great amount of energy. In terms of the method of power supply, the solar street lamps can be divided into: solar-commercial power hybrid street lamps, solar single power street lamps, and solar-wind power hybrid street lamps. The application of solar street lamps has saved a great amount of electric power, and their power supply is less dependent on or completely breaks away from the municipal power network. As a result, the traditional street-lamp control method is not suitable for the solar street lamps any more.

At present, the solar street lamps are controlled using photoelectric control or photoelectric in combination with time delay control. Unlike the traditional street lamps which are controlled jointly, flexibly and expediently, each solar street lamp is singly controlled and works independently becoming a separate unit due to breaking away from the power network. Due to different lamp location and dispersion of electronic elements in the circuit, the solar street lamps may be switched on or off unevenly, which will give an effect on the traffic safety and the urban landscape.

In terms of monitoring of street lamps, the whole current is monitored for traditional street lamps system to dope out the proportion of the lamps being on in good condition, which fails to inspect each single street lamp and achieve the detailed results. Moreover, it is through the on-site tour inspection or citizen's report and complaints to find out the faults in the lamps on the single pole. What is more, the street lamps powered by the solar energy will not rely on the power network and thus face more challenges in the monitoring. The tour inspection on the faults of lamps is a passive monitoring method, which only can rectify the faults after they occur. As a result, the hidden trouble can't be eliminated in time, which can lead to faults and damage. Most solar street lamps are controlled by themselves and therefore it is not convenient for service personnel to control and check them. In addition, the problems are more hidden, bringing much more difficulty to monitoring and maintenance.

Due to wide application of solar street lamp systems, it becomes increasingly urgent to invent a solar street lamp control system which possesses the advantages of traditional street lamp control system, adapts to the features of the solar street lamp and provides help to the monitoring personnel.

### SUMMARY OF THE INVENTION

The present invention is directed to an intelligent control system and control method for solar street lamps, which can provide a solution to centralized control over the self-governed solar street lamps, accurately set, control and monitor each piece of street lamp in the whole solar street lamp system, check the operating conditions of each street lamp, and help the management personnel to know the running conditions of each street lamp, find out the hidden problems in the street lamp, repair the lamps in time and thus nip the problems in the bud.

In one embodiment, the intelligent control system for solar street lamps includes at least a single pole system and manager with wireless communication interfaces respectively. The single pole system includes a controller, an LED lamp, a solar panel and a storage battery. The controller is used to monitor the operating data logging relevant to the solar panel and storage battery. The manager, connected with the main processor, is capable of modifying the parameter settings in the single pole system and saving the parameters in the controller.

The above-mentioned single pole system refers to the solar lamp system attached to the same lamp pole, including the controller, the storage battery, the solar panel, the lighting lamp and the structural parts etc.

For the purpose of controlling the operation and coordinating the working conditions between the single pole systems, each single pole system can serve as a wireless relay station transmitting the system commands and data to other single pole systems and managers via the wireless communication interface. Namely, the single pole systems can communicate with each other and transmit the data and commands to each other through the wireless signals.

The above controller includes a system control module, an electric energy management module, a memory, a wireless communication module and a photoelectric probe. The electric energy management module receives the solar energy collected by the solar panel and sends the solar energy to the storage battery and LED lamp, and also can get the electric energy from the storage battery. The system control module is respectively connected to the electric energy management module, memory, wireless communication module and photoelectric probe. The photoelectric probe is used for detecting the illumination on the road surface.

The quantity of single pole systems in the control system may be 1 to 999.

The above manager may be equipped with a USB interface through which the manager can be connected to the main processor. The computer may have the priority to be selected as the main processor.

The manager in the system only carries out the system setting, management and data acquisition but not involved in the daily operation of single pole system. The whole system can work by itself without the manager.

The control method for the intelligent control system of solar street lamp is featured by the following:

(a) The manager carries out the setting, management and data acquisition relevant to the single pole system.

The system setting parameters of the single pole system can be set and modified by the manager, and saved in the memory of the controller. After the street lamp management personnel set the parameters in the manager for each group of or single pole systems, these setting signals will be sent to the single pole system within the area covered by the wireless communication link. These setting signals are then transmitted by the single pole system to another single pole system repeatedly so that each single pole system adapts its system parameters to the requirements of the management personnel.

The manager sets and manages the single pole system with the following method:

\textcircled{1} Each single pole system is self-governed, so the manager assigns a number to each single pole system and thus includes the single pole systems in the range of management. Each single pole system also writes its number in the memory of its controller. The manager can delete any single pole system in the system managed.

\textcircled{2} The manager can divide single pole systems in the system into groups, and set different working parameters for them.

For the purpose of control and management, you'can organize multiple single pole systems in the same system into one group. Then you can define the same or similar settings for this group, and carry out the setting and control according to groups.

\textcircled{3} The manager can set any single pole system, or carry out the setting according to different groups of single pole systems, or set the whole system.

\textcircled{4} The manager can set the time for the whole system, so that all of the single pole systems within the management range are at the same system time.

Partial control operation of management system is based on the system clock of each single pole system. The manager is equipped with a time service function which is used for coordinating the system clock of each single pole system. Each single pole system automatically adjusts its system clock according to the command of time assigning from the manager, so that the system time in the whole management system is uniform.

\textcircled{5} The manager can control multiple arrays of solar street lamps at the same time, namely control a network domain.

The above-mentioned network domain: refers to the array formed by multiple single pole systems connected by wireless communication links in the same system. The arrangement of the array is not limited, and may be single lines, parallel lines, crossed, ring shaped and net shaped, but the wireless communication links must be continuous.

\textcircled{6} The switching time interval and grade of luminance can be set for each single pole system. It is also possible to set the time interval for switching off the street lamps late at night or for switching on the street lamps after the previous night.

Firstly, the single pole systems are divided into different groups. Then, the working parameters are set for each group, and the grade of luminance of street lamps can be lowered late at night or part of street lamps can be switched of according to the system clock. Whether to adjust the grade of luminance of each single pole system or switch off the control system is dependent on the system clock.

Data acquisition is performed as follows: the controller in the single pole system can monitor the operation of its own, and save these monitoring data in the memory. When needing data acquisition, enter the coverage area of one network domain and press the key of acquisition on the manager. The manager sends the command of data acquisition to this network domain. After one single pole system receives the command, it transmits the command to other single pole systems and sends its data packet to the manager. The manager returns a message of confirmation after receiving the data packet. Then the single pole system stops the data transfer. Another single pole system sends out its data packet according to priority. The data acquisition in the network domain does not stop until the monitoring data of each single pole system in the network domain is transferred to the manager. The data acquisition is carried out in each network domain if the management system has multiple network domains.

(b) The controller as mentioned above monitors and records the operation data logging relevant to the solar panel and storage battery of the street lamp in the single pole system.

The street lamp performs its work based on the setting parameters, coordinate the turning on and off time for the lamps in the same network domain in this way: at twilight, when the photoelectric probe in the controller detects the road illumination lower than a certain threshold value set by a single pole system, then the single pole system will send out turning on application signal with its number. After the other single pole systems receive the signal, they will perform voting and counting, like a bidding vote. Each single pole system has one vote to avoid repeated records. If any single pole system in the system counts enough counts to pass the vote, then it will send a lamp turning-on command to the system. After the single pole system receives the command, it will automatically turn on the LED lamp and meanwhile relay this command one by one, so that each single pole system in the system will be turned on. After the lamps are turned on, the voting will stop, and each single pole system will clear the voting records in preparation for the next vote. The turning-off operation in the morning are also performed in the same way. When the illumination is higher than the threshold value, the LED lamp will be automatically turned off. The time of turning on and off lamps are recorded in the memory of the single pole system.

(c) The above mentioned controller has set up a threshold value for the voltage of the storage battery. Through different threshold value, the electric charging and discharge of the storage battery is controlled.

Three threshold values have been set for the voltage of the storage battery by the electric energy management module of the controller: \textcircled{1} high point \textcircled{2} low point \textcircled{3} ultra low point, the charging and discharging of the mentioned storage battery is controlled through the 3 points as follows:

When the voltage of the storage battery reaches high point \textcircled{1}, charging is stopped;

When the voltage of the storage battery reaches low point \textcircled{2}, the discharge current is reduced;

When the voltage of the storage battery reaches ultra low point \textcircled{3}, the discharge is stopped.

When the voltage of storage battery reaches a threshold value, the time of reaching threshold value will be recorded in the memory of the mentioned controller.

(d) The mentioned manager will upload and analyze the data monitored by the controller:

A USB interface is placed on the Manager, and there is also PC management software. This software may acquire the data in the Manager and perform data processing. The monitoring data collected by the Manager will be stacked and stored based on lamp number and time of lamps. As long as the administrator create a new path by the prompt of the PC management software, the management PC will establish a data sheet for each single pole system based on the management scope of the Manager, combine the data acquired from the Manager based on lamp number and time sequence, to form a database of time gradation. As for the single pole system that joined in the management system later, the PC will add a database sheet for them. For single pole systems deleted midway, the PC will terminate the post operation to the corresponding data sheet files and give it corresponding tags. By analyzing the data sheet files, the PC management software will calculate the work conditions of each single pole system, and give relevant prompt for abnormal conditions. When the data sheet document increases to a certain level, PC will clue you to create a new management route. Only when this management route is created, can the management software carry out the subsequent operation.

After the above scheme is adopted, the whole control system will work as required, and can adjust the setting parameters of the street lamp system at any place at any time. Each solar street lamp can save the running data over a period of time, and report them to the manager. After receiving these data, the manager inputs them into the computer where they are processed by the processing software. Then, a clue is given on the operation management of each street lamp. The technical scheme of the invention can provide a solution to the centralized control over the self-governed solar street lamps, and can be used to accurately set, control and monitor each street lamp in the whole solar street lamp system, and check the operating conditions of each street lamp, so that the managerial personnel know the running conditions of each piece of solar street lamp and find out the problems hidden in the street lamps for the purpose of repair and nipping them in the bud.

### BRIEF DESCRIPTION OF THE DRAWINGS

FIG. 1 is a simplified schematic view of the control system.

FIG. 2 is a block diagram of the single pole system.

FIG. 2A is the circuit diagram of the system control modules.

FIG. 2B is the circuit diagram of the street lamp on-off regarding the control modules.

FIG. 2C is the circuit diagram of the electric energy management module.

FIG. 2D is the circuit diagram of the clock module of the controller.

FIG. 2E is the circuit diagram of the memory.

FIG. 2F is the circuit diagram of the charging switch of the storage battery.

FIG. 2G is the circuit diagram of the interface of wireless communication module.

FIG. 3 is a simplified schematic view showing the data uploading.

FIG. 3A is a circuit diagram of the data acquisition module.

FIG. 3B is the circuit diagram of the interface of the manager.

FIG. 4 is a block diagram showing the network domain.

FIG. 5 is a block diagram showing the wireless communication of the network domain

FIG. 6 are block diagrams showing the wireless communication signal transmission in the network domain.

FIG. 7 is a schematic view showing the management system of multiple network domains.

FIG. 8 is the data sheet set by the management system shown in FIG. 7.

FIG. 9 shows the numerical value list on the monthly time points and time intervals for switching on and off the street lamps calculated by the system in the example shown in FIG. 8;

FIG. 10 is a schematic view showing groups of single pole systems.

FIG. 11 is a circuit diagram showing the combined connection of the control modules.

### DESCRIPTION OF THE EMBODIMENTS

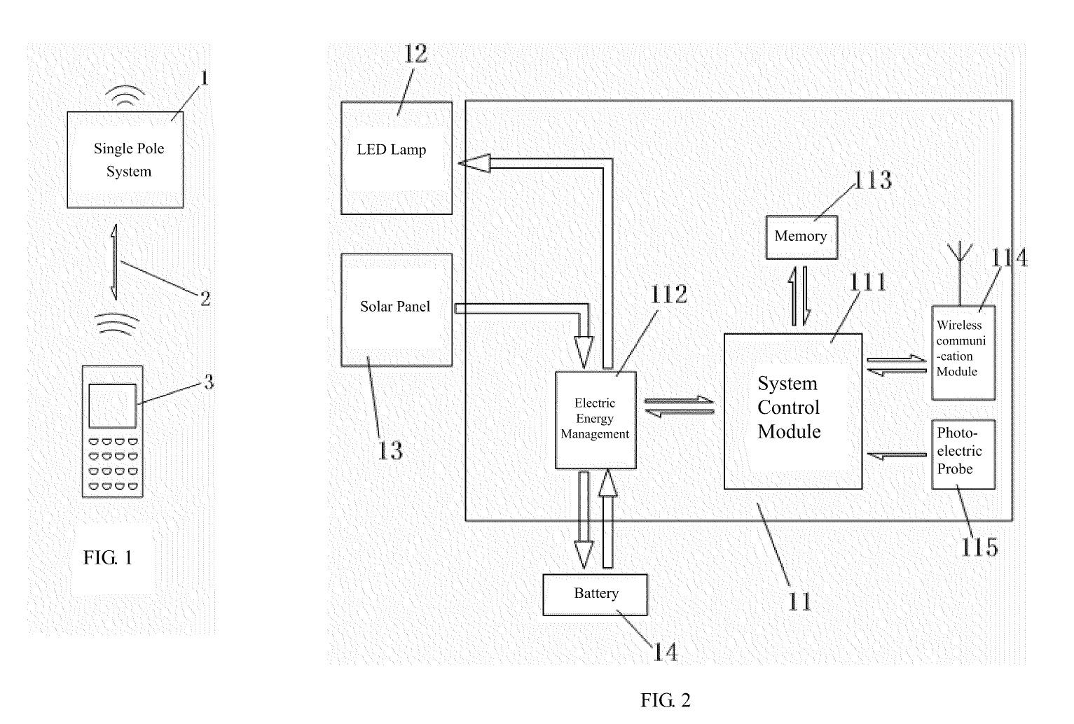

Referring to FIG. 1, an intelligent control system for solar street lamps in accordance with one embodiment includes a single pole system 1 with a wireless communication interface 2, and a manager 3 with a wireless communication interface.

The single pole system 1 includes a controller 11, an LED lamp 12, a solar panel 13 and a storage battery 14. The controller 11 can monitor the operating data logging relevant to the solar panel 13 and storage battery 14, while the manager 3 can modify the parameter settings in the single pole system 1 and save the parameters in the controller 11.

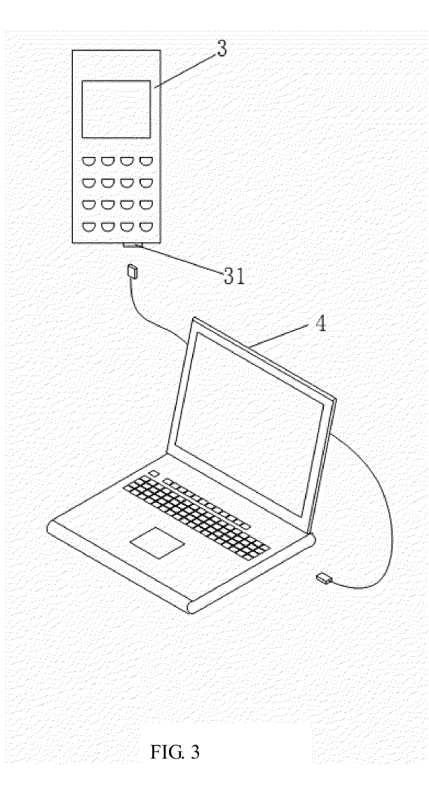

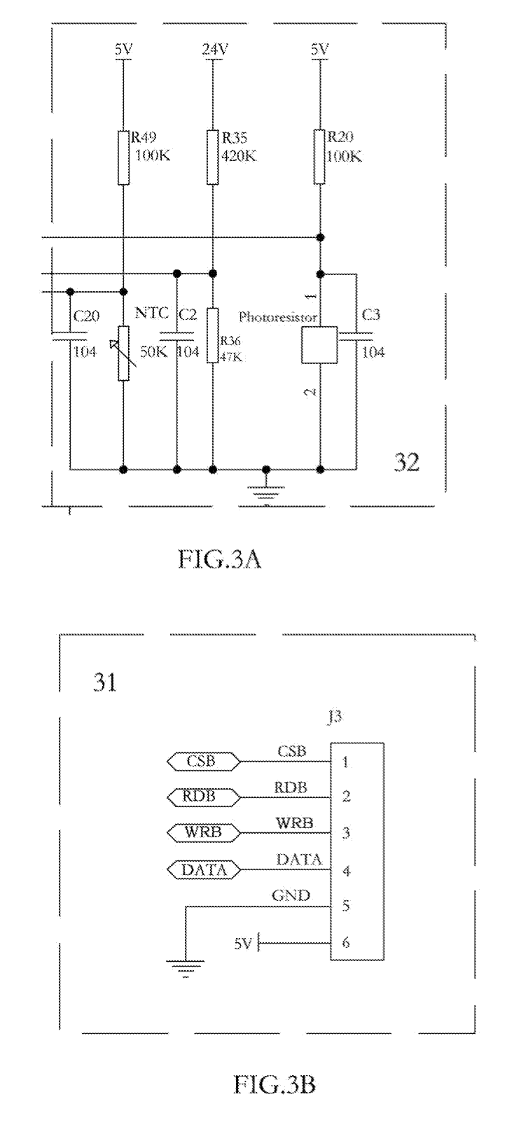

As shown in FIG. 3, the manager 3 is equipped with a USB interface 31 through which manager 3 can be connected to the computer 4.

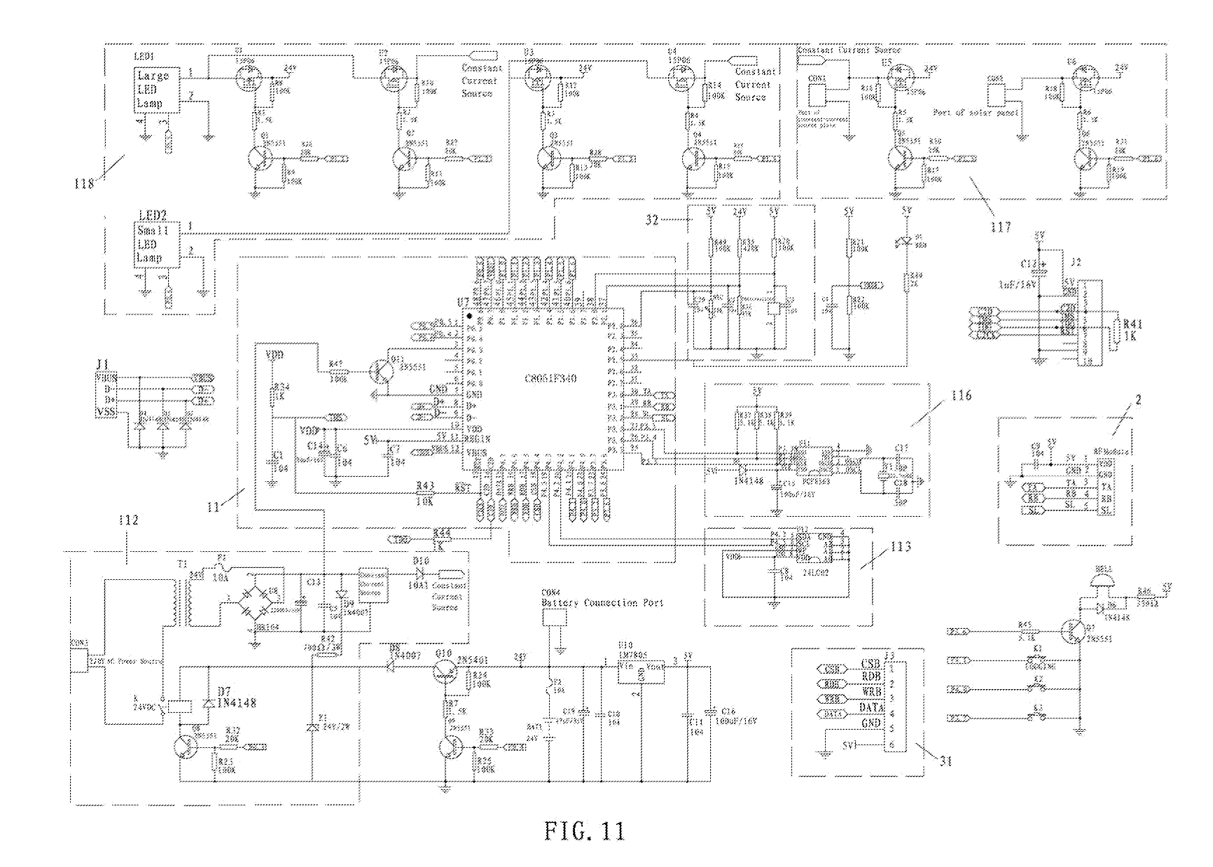

As shown in FIGS. 3A and 11, the data acquisition module 32 is mounted in the manager 3 and used for collecting the voltage of battery, ambient temperature and luminance of outdoor light ray. The voltage of battery collected can be used to judge the electric quantity of battery; the ambient temperature can be used to judge the working conditions of circuit so as to give an alarm in case of high temperature and cut off of the power supply, protect the components from fire breakout, or the like. The outdoor light ray is used to judge whether it is in the daytime or at night, so as to control the working conditions and method of LED lamps.

As shown in FIG. 3B, the USB interface 31 on the manager 3 is connected to the interface on the display of computer 4. The display will show the messages on the operation of street lamps after connection.

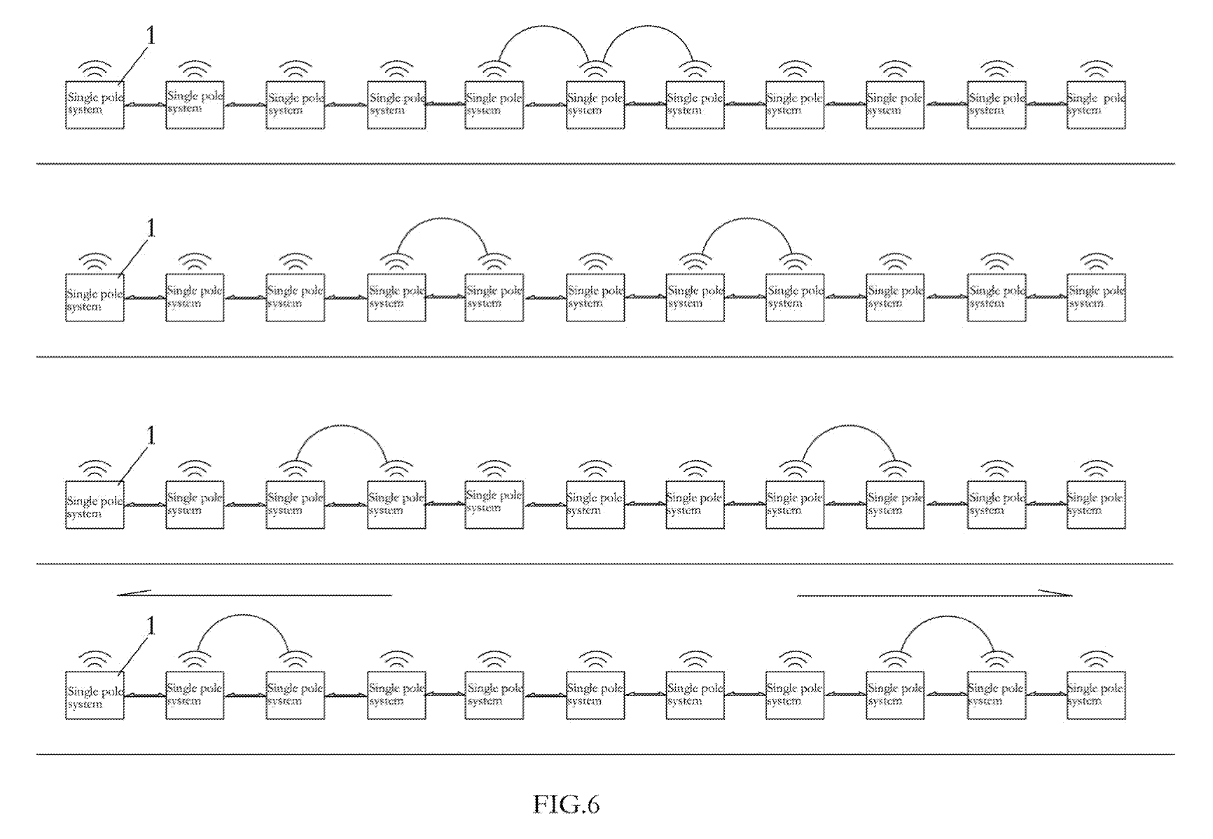

As shown in FIG. 6, each single pole system 1 can serve as a wireless relay station transmitting the system commands and data to other single pole systems and managers 3 in turn via the wireless communication interface. Namely, the single pole systems 1 can communicate with each other and transmit the data and commands to each other through the wireless signals.

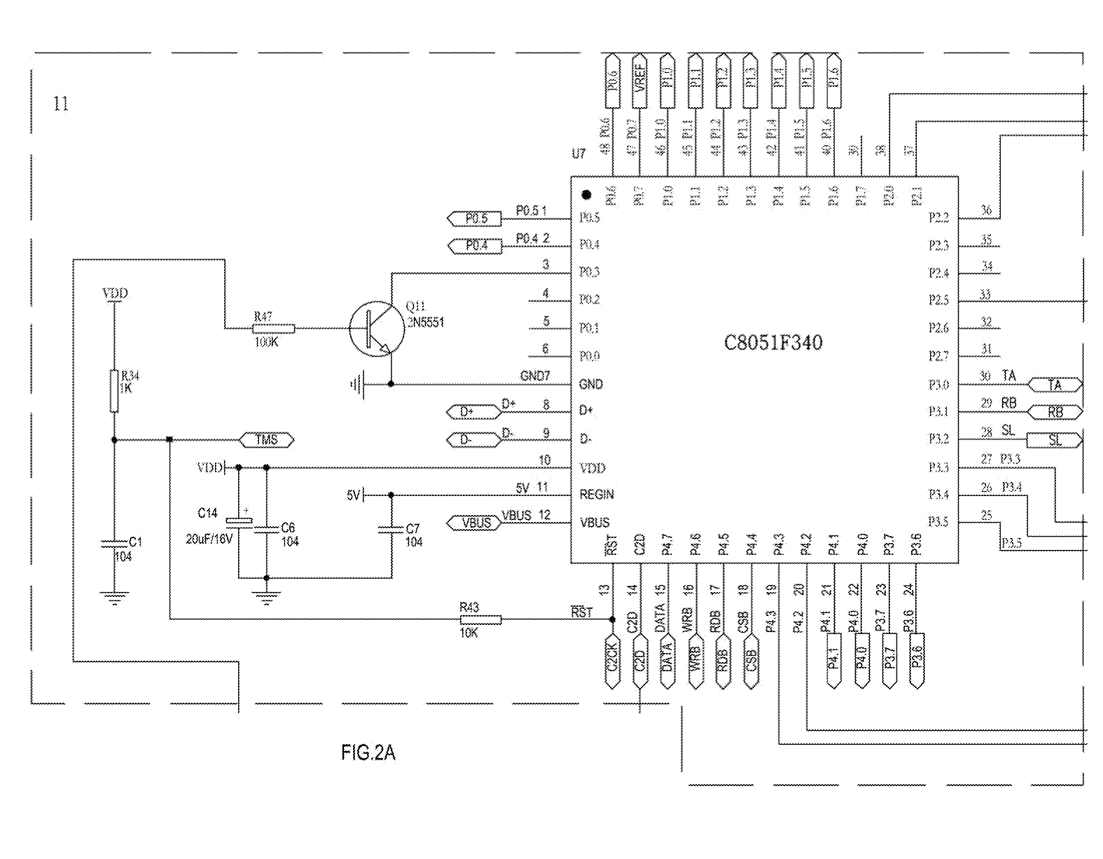

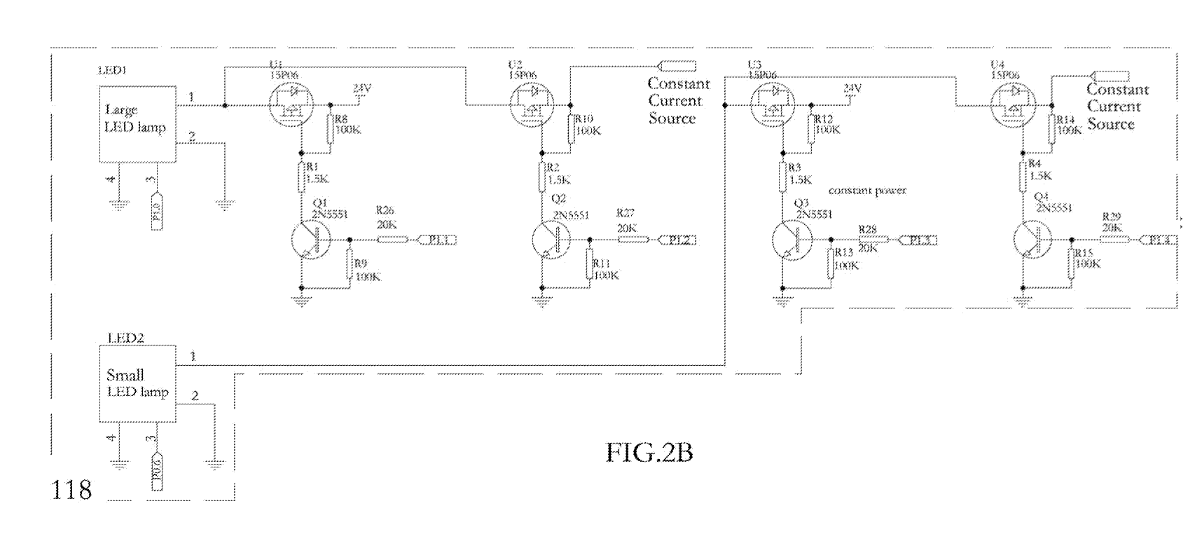

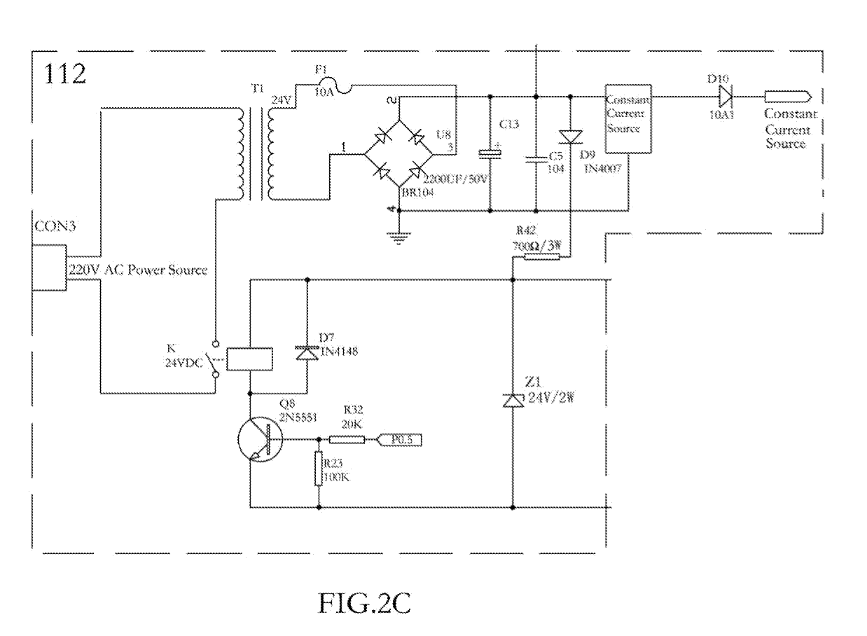

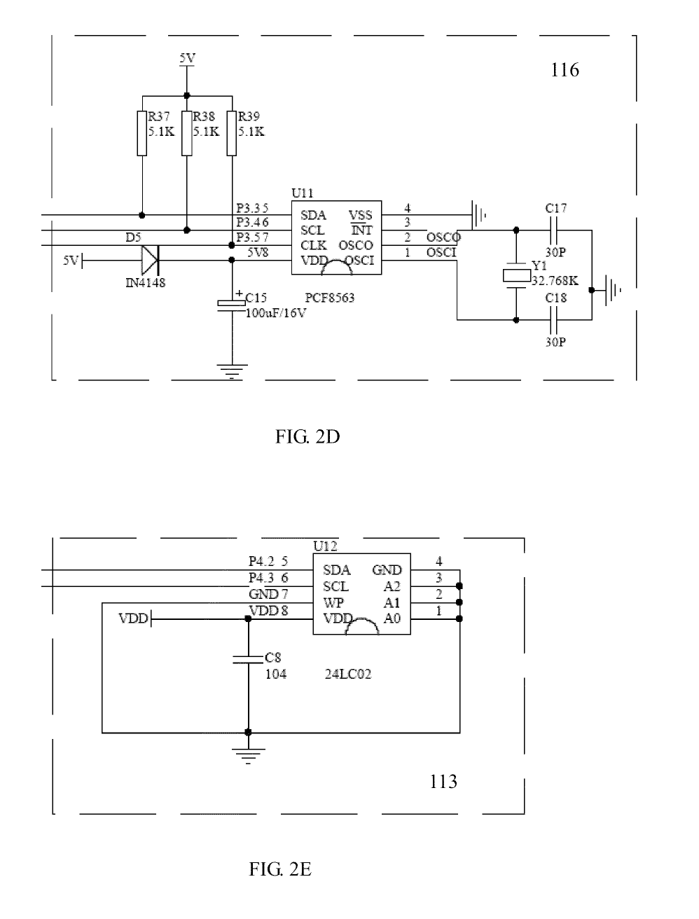

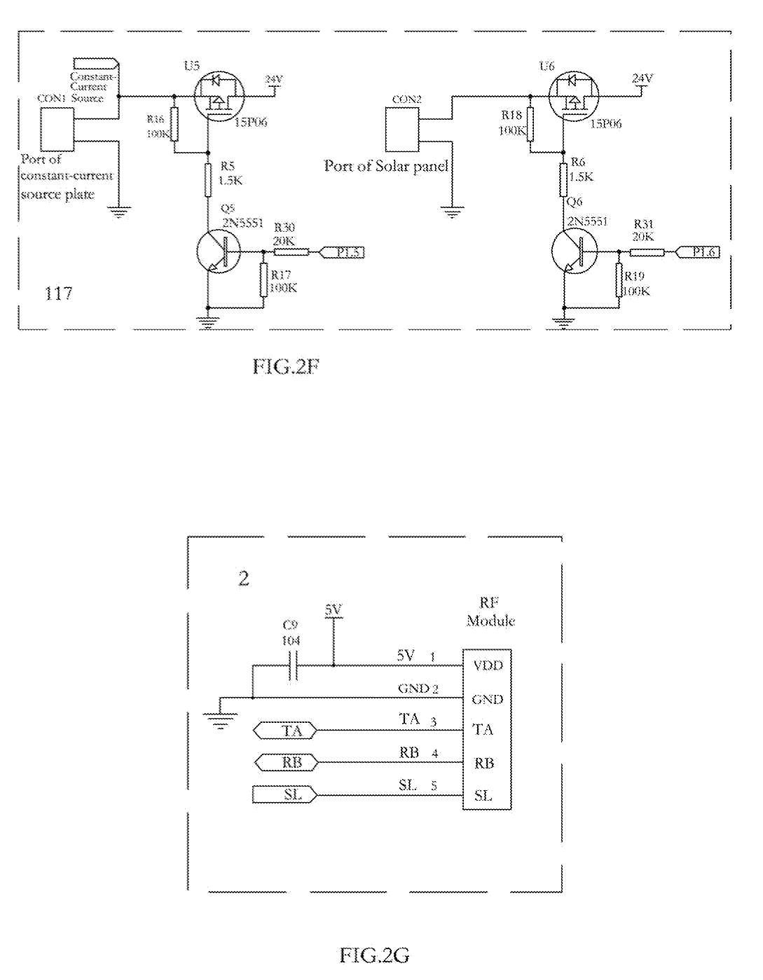

As shown in FIG. 2, the controller 11 includes a system control module 111, an electric energy management module 112, a memory 113, a wireless communication module 114 and a photoelectric probe 115. The electric energy management module 112 receives the solar energy collected by the solar panel 13 and sends the solar energy to the storage battery 14 and LED lamp 12, and also can get the electric energy from the storage battery 14. The system control module 111 is respectively connected to the electric energy management module 112, memory 113, wireless communication module 114 and photoelectric probe 115. The photoelectric probe 115 is used for detecting the illumination on the road surface.

As shown in FIGS. 2A and 11, the system control module 11 is the control center with a processing speed up to 48 MIPS, and can process all kinds of complicated commands including data sampling, switch changeover and data communication, etc. It realizes the core functions of all-automatic energy-saving control system for LED solar street lamps, and can carry out all types of control tasks for the system.

As shown in FIGS. 2B and 11, the controller 11 also contains a street-lamp switching circuit 118 which, realizes the power supply control switch for solar LED lamp, can exercise on-off and semi-on control over the LED lamps.

As shown in FIGS. 2C and 11, the electric energy management module 112 can convert the storage battery 14 into a constant power supply for the LED lamp 12, so that the LED lamp 12 can get the electric energy from the storage battery 14 in case that the battery runs out.

As shown in FIGS. 2D and 11, the controller 11 also contains the clock module 116 providing the real-time clock data on the LED lamp system. These real-time clock data can be used for judging whether it is in the daytime or at night. When the outside light ray (in the daytime or at night) is different from the data of the real-time clock, the control center will judge whether to switch on or off the LED street lamps, or whether to treat the errors. Additionally, in the event that the system is switched off, the clock module is still electrified, and able to provide the clock messages after the system is restarted. Therefore, there is no need to check the time again.

As shown in FIGS. 2E and 11, the memory 113 is used for storing the working conditions and historical data on the LED lamp 12 as well as some configuration messages on the working flow of the LED lamp 12.

As shown in FIGS. 2F and 11, the controller 11 also contains the charging switching circuit 117 which serves as the charging switching circuit for the storage battery. Through the switching circuit, the control system module 111 determines whether to charge the storage battery 14 according to the electric quantity of battery, outside light ray and ambient temperature, etc. The control system module 111 also determines whether to charge the storage battery from the power grid or solar energy.

As shown in FIGS. 2G and 11, the wireless communication interface 2 can be connected with the universal wireless standard module and is compatible with multiple communication baud rates based on FSK modulation method, such as 9600 bps, 19200 bps, 38400 bps, 57600 bps, and 115200 bps, etc. The control center is connected with the standard wireless module through the wireless transmission interface, and can adopt the software to control the street lamps within the coverage range of wireless signal and transmit the data, figure out the conditions of surrounding LED street lamp groups, keep the communication, record and save the data, and transmit the data to other street lamp groups. This wireless transmission interface does not involve the carrier frequency so different carrier frequencies can be adopt in different areas or countries.

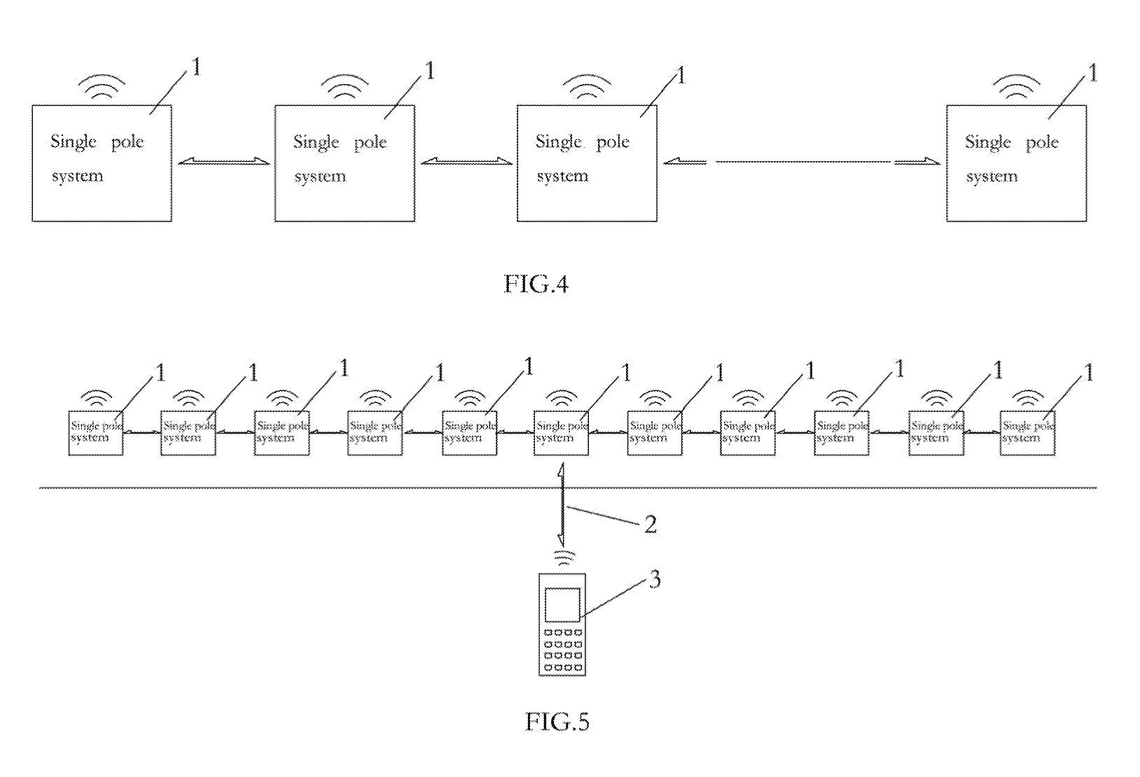

As shown in FIG. 5, the network domain is arranged in an array formed by multiple single pole systems 1 in the same system connected by continuous wireless communication links. The arrangement of the array shown in FIG. 5 is of a single line.

As shown in FIG. 6, each single pole system in the network domain in FIG. 5 is connected to the manager 3 via the wireless communication interface 2, with a continuous wireless communication link.

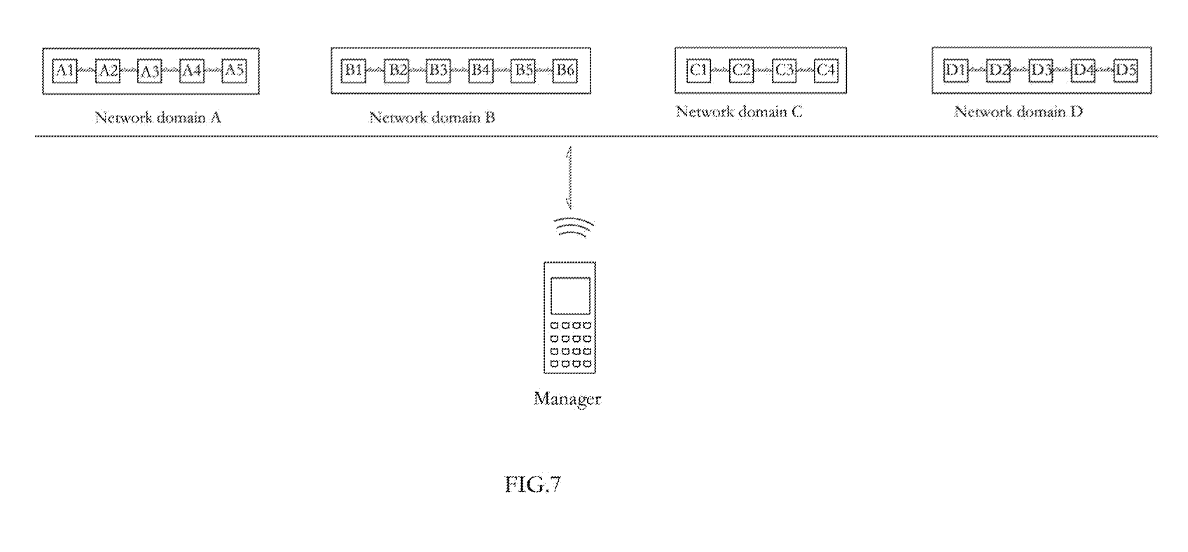

FIG. 7 illustrates a multiple network domain intelligent solar street-lamp control system including four network domains A, B, C and D and one manager 3. All of the single pole systems 1 in the control system feature single pole and one lamp, are of single-side arrangement and divided into four network domains A, B, C and D with routes continuously passing through three tunnels.

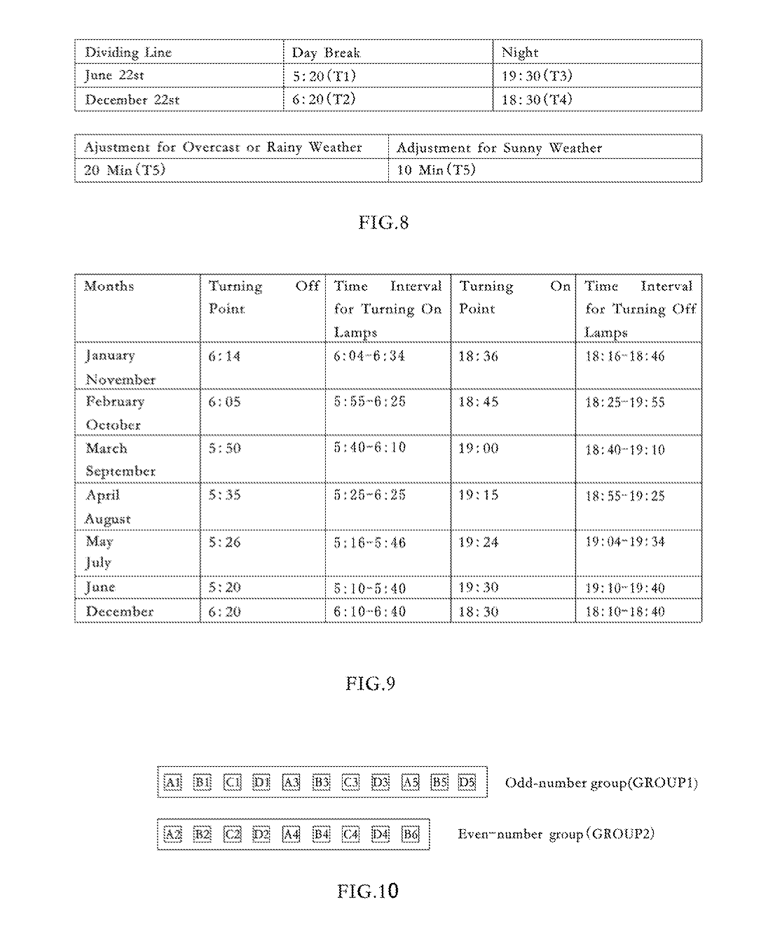

As shown in FIG. 10, the control system contains four network domains and two system-level groups, arranged as follows:

Network domain A contains five single pole systems 1 numbered with A1, A2, A3, A4 and A5 respectively.

Network domain B contains five single pole systems 1 numbered with B1, B2, B3, B4, B5 and B6 respectively.

Network domain C contains five single pole systems 1 numbered with C1, C2, C3 and C4 respectively.

Network domain D contains five single pole systems 1 numbered with D1, D2, D3, D4 and D5 respectively.

Group GROUP1 contains 11 single pole systems 1 numbered with A1, B1, C1, D1, A3, B3, C3, D3, A5, B5, D5 respectively.

Group GROUP2 contains 9 single pole systems 1 numbered with A2, B2, C2, D2, A4, B4, C4, D4 and B6 respectively.

The control method is described below in conjunction with the control system of FIGS. 7 and 10.

(a) The Manager 3 as mentioned above performs the set up, administration and data collection of the above mentioned single role system 1 in the system.

I Before including the single pole systems into the system, and assigning numbers to them, the Manager 3 must be configured, the configuration is as follows in the present embodiment:

\textcircled{1} Seasonal fluctuation set up and adjustment quantity setting

Fill in the morning/evening local cut-off point respectively for the dates of June 22nd and December 22nd in the morning/evening seasonal fluctuation set up item in the Manager 3. (The approximate sunny day around that particular date)

Referring to FIG. 8, the data displayed are based on Shenzhen

Based on the four time points above, the system will calculate the time interval between turning on and off the lamp for each month.

In the present embodiment, the time of turning on/off lamp and time interval are as follows:

tav1=(T2+T1)/2 - - - 5:50

Δtmax=30 min

ΔtN=30*sin(360*(N−3)/12))=30*sin(30*(N−3))

tN1=tav+30*sin(30*(N−3))

Where, N represents the month and other terms and phraseology are explained below one by one.

Overcast and rainy adjustment: The maximum extent of turning on lamp earlier and turning off lamp later during overcast and rainy weather.

Sunny day adjustment: The maximum extent of turning on lamp later and turning off lamp earlier during sunny weather.

Referring to FIG. 9, particular data on the time point and intervals of turning the lamp on and off each month as calculated by the system of the present embodiment are shown.

Lamp turning-on time interval: When the lamp under normal operation status reaches this time interval, and if the road illumination is lower than the threshold settings, the single pole system will send a lamp turn-on application, after the voting has passed the application, the lamps will turn on.

Lamp turn-off time interval: When the lamp under normal operation status reaches this time interval, and if the road illumination is higher than the threshold settings, the single pole system will send a lamp turn-off application, after the voting has passed the application, the lamps will turn off.

Based on the 6 time settings above, the system will integrate system set-up based on road illumination, and automatically coordinate the turning-on and off time for each day; automatically adjust the turning-on and off time interval each month, meanwhile the system is capable of eliminating abnormal turning on or off of lamp.

\textcircled{2} Network domain set up and corresponding voting value settings:

Corresponding to the road illumination drawing, in the present embodiment, 4 network domains of A, B, C and D are set up in the manager network domain settings. The voting value of A network domain is 3, the voting value of B network domain is 3, the voting value of C network domain is 2, and the voting value of D network domain is 3.

Based on the above voting value settings, if there are 2 single pole systems that sent lamp turning on or off applications and another single pole system will send turning on or off command to the entire network domain if it detects itself to fit the criteria of turning the lamp on or off, the entire network domain will operate. It is the same way of voting that controls turning on and off in the B, C, and D network domains.

\textcircled{3} Pre-settings of power-saving mode

The Manager provides power-saving settings, there are 2 areas to be set: the method of power saving and the start-up time of power saving mode.

The start up time of power saving mode is based on local conditions, the way to set up is to enter a time when both pedestrian and traffic flow decreases significantly.

There are 3 fixed options for power saving mode: Default/Light up every other lamp/Half lit, which are described below.

Default: No power saving mode is set up in the default mode, and no time set up is needed for this option.

Light up every other lamp: When the power saving mode start up time has arrived, one system group shall shut down, while the other stay turned on, the same pattern will be rotated the next day. (If late at night last night, the Group 1 turn off and Group 2 stays lit, then when tonight arrives, and power saving mode starts, then Group 1 will stay lit and Group 2 will turn off, etc)

Half lit: When late night arrives, and the power saving mode starts, both group 1 and 2 keeps working, but in that period, their illumination will decrease by half until the lamps turn off in the morning.

Setting up of power saving mode in the present embodiment is as follows:

Power saving method: choose to light up every other lamp

Start up time for power saving mode: 23:30

\textcircled{4} Creating system and system groups

In the group set up of the Manger, the system has already pre-set two system level groups: odd number GROUP1 and even number GROUP2. When every single pole system is included in the management system, they have a group option: GROUP1/GROUP2/NONE, where NONE means the single pole system does not join any system level groups. The three options are mandatory and one must choose one of them.

\textcircled{5}Setting of system time: Set the Manager system, in this embodiment, to standard Beijing time.

\textcircled{6} Administrator password set up: In order to prevent non-administrator personnel from operating the system, it is suggested to set up a password for the Manager. The administrator password of the Manger in this embodiment is 25261329.

By now the Manager's system configuration is basically completed.

The system configuration of the Manager can also be revised later by the administrator password, but after the revision, the data must be transmitted to each network domain once to function in the network domains. However, if they are set up in the Manager before the installation, then the Manager will automatically pass the set up data to each single pole system when they are being included in the system.

II. The Installation Set Up of Single Pole System 1:

\textcircled{1} Each single pole system 1 includes a controller 11, and an LED lamp 12 of 120 W, two solar panel 13 of 180 W, and two lead-acid battery 14 of 12V 150 A. The controller 11 contains a system controlling module 111, a power management module 112, a memory 113, a wire-less communications module 114, and a photo-electricity probe 115.

\textcircled{2} Each single pole systems are installed at appointed locations based on road construction drawing, with direction angle pointing south (for the southern hemisphere, point to north south direction). The elevation angle is determined by the geographical latitude of the installation location and produced when manufacturing the solar panel fixture frame.

\textcircled{3} After the installation and testing are completed for each single pole system, the construction would have reached its end, and then the single pole system inclusion will be performed.

III. Single Pole System Inclusion into Management System:

In the A network domain: the manger is first started. Upon pressing the inclusion shortcut key, the Manager prompts for entering single pole system numbers, choosing the network domain number and choosing the group.

A1 is first entered for the single pole system numbers, A is chosen for network domain number, and GROUP1 is chosen for system group selection. Upon long pressing the set up key of single pole system controller and pressing the confirm key of the manager, the Manager starts assigning numbers and sends all the set up information to the A1 single pole system. After the single pole system receives and processes the information, it sends feedback information to the Manager; after the Manager receives A1 single pole system's feedback information, it will prompt task completion. A2, A3, A4, A5 are then included in sequence. The inclusion of A network domain is thus finished. Then the B, C and D network domains are set up in the same way. The inclusion of the entire system is thus completed.

(b) The controller 11 as mentioned above monitors and records the operation data logging relevant to the solar panel 13 and storage battery 14 of the street lamp in the single pole system 1.

Lamp 12 performs its work based on the setting parameters. Turning on and off time for the lamps in the same network domain are coordinated in such a manner that, at twilight, when the photo-electric probe in the controller 11 detects the road illumination lower than a certain threshold value set by a single pole system, then the single pole system will send out turning on application signal with its number; after the other single pole systems receive the signal, they will perform voting and counting, like a bidding vote; each single pole system has one vote to avoid repeated records; if any single pole system in the system counts enough counts to pass the vote, then it will send a lamp turning-on command to the system; after the single pole system receives the command, it will automatically turn on LED lamp 12, meanwhile relay this command one by one, so that each single Pole system in the system will turn on; after the lamps are turned on, the voting will stop, and each single pole system will clear the voting records in preparation for the next vote. The turning-off operations in the morning are also performed in the same way. When the illumination is higher than the threshold value, the LED lamp 12 will be automatically turned off. The time of turning on and off lamps are recorded in the memory 113 of the single pole system 1.

(c) The above mentioned controller (11) has set up a threshold value for the voltage of the storage battery (14), through different threshold value, the charging and discharge of the storage battery (14) is controlled.

Based on the threshold value set at step (a): \textcircled{1} high point \textcircled{2} low point \textcircled{3} ultra low point, the charging and discharging of the mentioned storage battery is controlled through the 3 points.

When the voltage of the storage battery reaches high point \textcircled{1}, charging is stopped;

When the voltage of the storage battery reaches low point \textcircled{2}, the discharge current is reduced;

When the voltage of the storage battery reaches ultra low point \textcircled{3}, the discharge is stopped.

When the voltage of a storage battery reaches a threshold value, the time of reaching threshold value will be recorded in the memory of the mentioned controller.

(d) The mentioned manager will upload and analyze the data monitored by the controller.

A USB interface 31 is placed on the Manager 3, there is also PC management software, and this software may acquire the data in the Manager 3 and perform data processing. The monitoring data collected by the Manager will be stacked and stored based on lamp number and time of lamps. As long as the administrator create a new path upon the prompt of the PC management software, the management PC will establish a data sheet for each single pole system based on the management scope of the Manager, combine the data acquired from the Manager based on lamp number and time sequence, to form a database of time gradation. As for the single pole system that is joined in the management system later, the PC will add a database sheet for them. For single pole systems deleted later, the PC will terminate the post operation to the corresponding data sheet files and give it corresponding tags. By analyzing the data sheet files, the PC management software will calculate the work conditions of each single pole system, and give relevant prompts for abnormal conditions. When the data sheet file size has grown to a certain extent, the PC will prompt to create a new management path. Only after the management path has been created, can the post operation of the management software be carried out.

Also, in order to prevent any damage to Manager 3 that affects system management, and for easier operation, the PC management software of this system also supports Manager back up function.

Manager backup: After the system inclusion is completed, or after revising the system, it is recommended to perform Manager back up. The Manager backup is performed as follows. The Manager 3 is first connected to a computer 4 through a USB interface 31. The management software is turned on the computer 4. The back up button of the Manager is clicked. The original Manager is taken off and the Manager for the back up is plugged in. The system then automatically completes the Manager backup.

In this way, the entire set up of the original Manager will be copied into the new Manager, including the Manager number which will be revised to be the same as the new Manager. The new Manager can completely replace the original Manager for operation.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An intelligent control system for solar street lamps comprising: at least a single pole system with a wireless communication interface, and a manager with wireless communication interfaces, wherein the single pole system comprises a controller, an LED lamp, a solar panel and a storage battery, the controller is configured for monitoring the operating data logging relevant to the solar panel and storage battery, and the manager, connected to a main processor, is configured for modifying the parameter settings in the single pole system and saving the parameters in the controller.

2. An intelligent control system of claim 1, wherein the controller comprises a system control module, an electric energy management module, a memory, a wireless communication module and a photoelectric probe, the electric energy management module receives the solar energy collected by the solar panel and sends the solar energy to the storage battery and the LED lamp, and also gets the electric energy from the storage battery, the system control module is respectively connected to the electric energy management module, memory, wireless communication module and photoelectric probe, the photoelectric probe is configured for detecting the illumination on the road surface.

3. An intelligent control method to be performed by the control system for solar street lamps of claim 2, wherein:
(a) the manager in the system is configured for setting, management and data acquisition relevant to the single pole system;
(b) the controller is configured for monitoring the operating data logging relevant to the solar panel and storage battery of the street lamp in the single pole system;
(c) the controller is configured for setting the threshold value for the voltage of storage battery and thus controlling the electric charging and discharge of storage battery by means of the threshold value; and
(d) the above-mentioned manager is configured for uploading the data monitored by the controller for analysis and processing.

4. An intelligent control method of claim 3, wherein at step (b), the LED lamp is automatically switched on if the illumination level on the road detected by the photoelectric probe of the controller is lower than the threshold value set by the manager, and the LED lamp is automatically switched off if the illumination level exceeds the threshold value.

5. An intelligent control method of claim 4, further comprising the steps of recording the time in the memory of the single pole system when the lamp is switched on or off.

6. An intelligent control method of claim 3, wherein at step (c), the electric energy management module in the controller sets three threshold values for the voltage of the storage battery, namely, a high point \textcircled{1}, a low point \textcircled{2} and an ultra low point \textcircled{3}, which are used for controlling the electric discharge and charging of the storage battery such that:
the charging is stopped when the voltage of storage battery rises to high point \textcircled{1};
the discharging current is lowered when the voltage of storage battery falls to low point \textcircled{1}; and
the electric discharge is stopped when the voltage of storage battery falls to ultra low point \textcircled{3}.

7. An intelligent control method of claim 6, further comprising recording the corresponding time in the memory of the controller when the voltage of the storage battery reaches the threshold value.

8. An intelligent control method of claim 3, further comprising assigning a number to each single pole system by the manager such that the single pole system is included in the management range, wherein the single pole systems are independent of each other, and the number of each single pole system is written in its controller.

9. An intelligent control method of claim 3, wherein the manager assigns a number to each single pole system, and the number is written in the controller of the corresponding single pole system.

10. An intelligent control method of claim 3, wherein the manager is configured for setting the time for the whole control system so that all of the single pole systems are at the same system time.

11. An intelligent control method to be performed by the control system for solar street lamps of claim 1, wherein:
(a) the manager in the system is configured for setting, management and data acquisition relevant to the single pole system;
(b) the controller is configured for monitoring the operating data logging relevant to the solar panel and storage battery of the street lamp in the single pole system;
(c) the controller is configured for setting the threshold value for the voltage of storage battery and thus controlling the electric charging and discharge of storage battery by means of the threshold value; and
(d) the above-mentioned manager is configured for uploading the data monitored by the controller for analysis and processing.

12. An intelligent control method of claim 3, further comprising assigning a number to each single pole system by the manager such that the single pole system is included in the management range, wherein the single pole systems are independent of each other, and the number of each single pole system is written in its controller.

13. An intelligent control method of claim 3, wherein the manager assigns a number to each single pole system, and the number is written in the controller of the corresponding single pole system.

14. An intelligent control method of claim 3, wherein the manager is configured for setting the time for the whole control system so that all of the single pole systems are at the same system time.
